(19) United States
(12) Patent Application Publication
(10) Pub. No.: US 2025/0355241 A1
(43) Pub. Date: Nov. 20, 2025

(54) SCANNING APPARATUS

(71) Applicant: SICK AG, Waldkirch (DE)

(72) Inventor: Jonas FÖLLING, Freiburg (DE)

(21) Appl. No.: 19/211,078

(22) Filed: May 16, 2025

(30) Foreign Application Priority Data
May 17, 2024 (DE) 102024113999.4

(51) Int. Cl. G02B 26/12

(52) U.S. Cl. CPC G02B 26/127; G02B 26/121

(57) ABSTRACT

The present invention relates to a scanning apparatus, in particular a laser scanner. The scanning apparatus comprises a detector arrangement having a plurality of optical detectors; a scanning module that is configured to vary the position and/or the orientation of the field of view of the detector arrangement in order to define a corresponding scanning zone; and an evaluation unit that is configured to obtain information on objects in the scanning zone of the scanning apparatus from the combined detection signals of the detectors of the detector arrangement. According to the invention, the optical detectors of the detector arrangement are designed in the form of at least two detector arrays that are oriented identically to one another and that each have at least three optical detectors arranged linearly in a row. According to the invention, said detector arrays are arranged on a common circular ring that extends perpendicular to the common orientation of said detector arrays.

The present invention relates to scanning apparatus, in particular laser scanners, for periodically scanning a defined scanning zone or monitoring zone.

Conventional scanning apparatus regularly comprise a detector arrangement having a plurality of optical detectors. In order, with such a scanning apparatus, to be able to scan a scanning zone that is larger and/or denser than the simple field of view of the detector arrangement, it is known to provide a scanning module in order to vary the field of view of the detector arrangement. For example, the scanning module can bring about a rotation of the detector arrangement. The thus obtained variation of the field of view compared to a fixed base of the scanning apparatus defines a scanning zone of the scanning apparatus. A further provided evaluation unit finally serves to obtain various information on objects within the scanning zone from the combined detection signals (for example in the form of a 3D point cloud) of the different detectors of the detector arrangement. This information regularly in particular includes distance information. Alternatively and/or in addition thereto, it would, however, also be conceivable to obtain other information on the surface properties, such as the color, the roughness and/or the material, of objects in the scanning zone of the scanning apparatus.

It is desirable to acquire information of the scanning zone as accurately as possible using the detector arrangement.

It is an object of the present invention to provide a scanning apparatus having a particularly efficient design of the detector arrangement with a particularly fine scanning of the respective scanning zone.

This object is satisfied by the scanning apparatus according to claim 1. Advantageous further developments are defined in the dependent claims.

The scanning apparatus according to the invention is characterized in that the optical detectors of the detector arrangement are designed in the form of at least two separate identically oriented detector arrays that each have at least three optical detectors arranged linearly in a row. According to the invention, said detector arrays are arranged on a common circular ring that extends perpendicular to the common orientation of said detector arrays.

The term “detector array” is understood in the present case as a combined module having a plurality of detectors that are all aligned in parallel with one another and that are arranged in a checkerboard pattern (or in a row) on a common carrier plate. Such a detector array usually has a common data output for the entirety of its individual detectors. Said common data output can be preceded by an internal processing unit that forms a combined output signal, in particular in digital form, from the individual detector signals. Combined here means that the signals of the individual pixels can still be associated with the respective pixels and are not added together. A pixel can consist of further sub-units whose signals add up to the signal of the pixel (e.g. an SiPM). The individual detectors of the detector array each define the detection signal of a pixel of the respective detector array. Classic pixel numbers of such detector arrays are powers of two, such as 8, 16, 64, 128, 254. The length of corresponding arrays is regularly in the millimeter range for the intended use, while the outer diameter of the common circular ring is regularly in the centimeter range. In the case of a corresponding scanning movement, it is not necessary to provide further optical detectors within the common circular ring. In particular, no further optical detectors are provided within the common circular ring. Here, for example, a control board of the scanning apparatus and/or of the detector arrangement and/or a light source arrangement can be provided to illuminate the field of view of the detector arrangement.

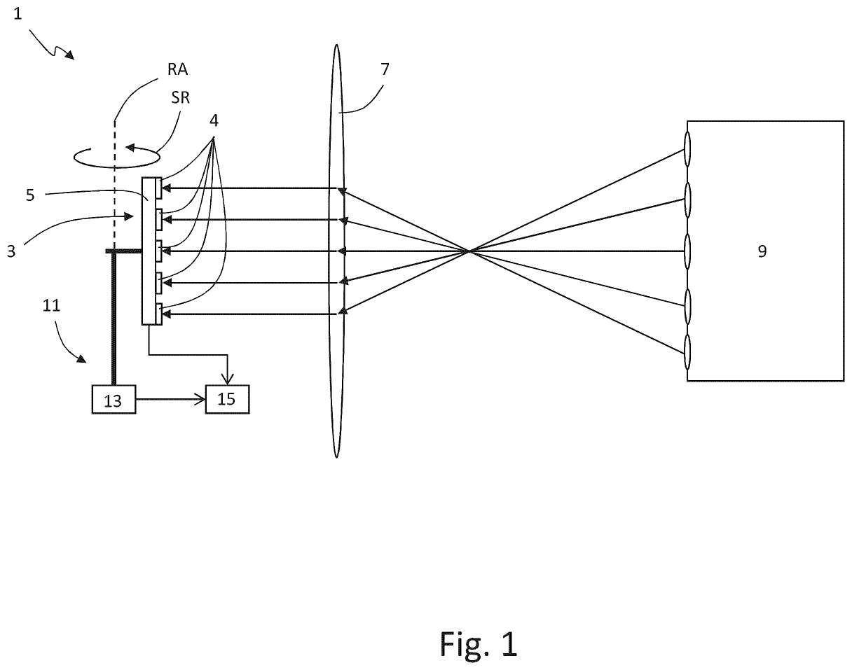

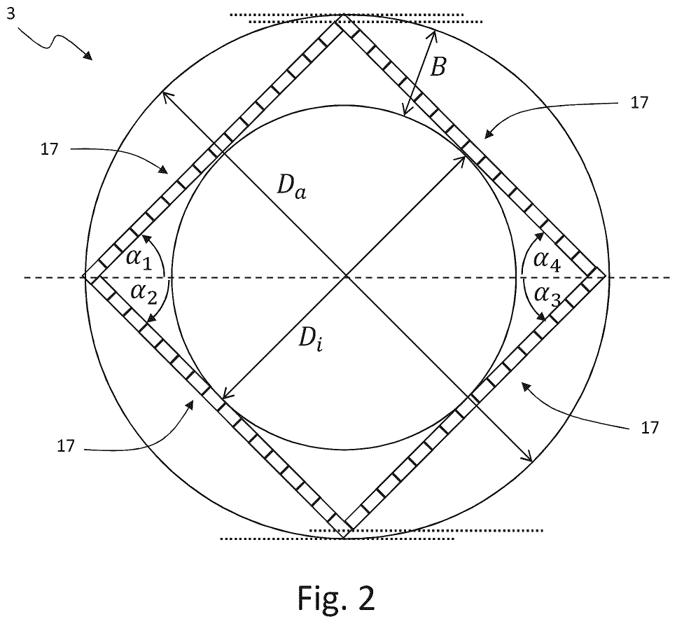

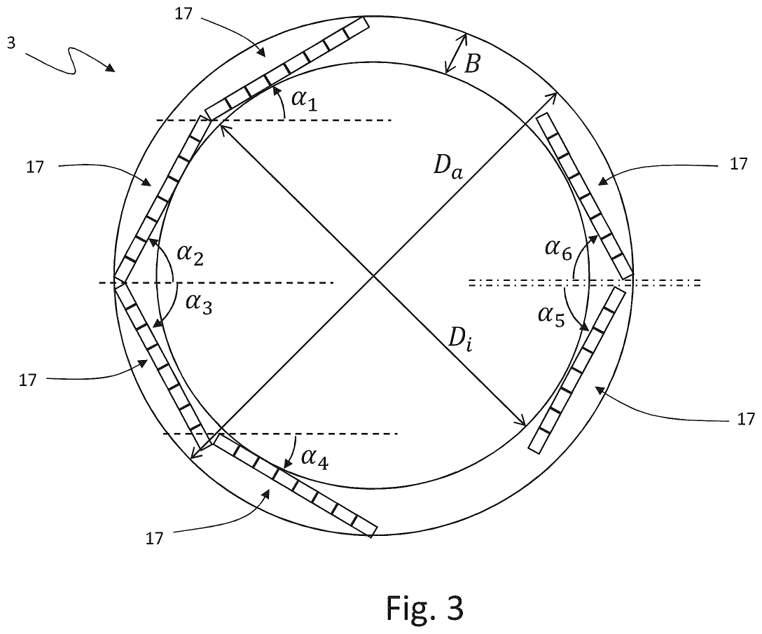

The common orientation of the detector arrays is in the present case to be understood as the common viewing direction of the individual detectors of the detector arrays provided. In FIG. 1, said common viewing direction extends horizontally in the image plane, while it extends perpendicular to the image plane in FIGS. 2 and 3. The detector arrays each extend perpendicular to said orientation.

The use of detector arrays enables a particularly dense packing of the individual detectors of the detector arrangement and thus the minimization of the gap dimension between the individual pixels of the detector arrangement. The specific arrangement of these detector arrays on a common circular ring leads to a transverse position of the individual detector arrays relative to a scanning direction of the scanning apparatus at different angles.

The scanning direction corresponds to the direction of a provided movement of the field of view of the detector arrangement. As mentioned, the individual detector arrays can be arranged obliquely to the scanning direction, for example at an angle between 20° and 70° to the scanning direction, preferably between 30° and 60°. Different detector arrays can be arranged parallel with one another or orthogonally to one another (in a plan view). This slanted position, in particular in combination with the particularly dense packing of the detectors in the form of the detector arrays, allows a completely closed scanning zone to be imaged in particular detail since more pixels can be arranged viewed in the scanning direction than in an arrangement without a slanted position with respect to the scanning direction.

Thus, the embodiment according to the invention differs both with respect to the design and with respect to the efficiency from embodiments with only a single large detector array, which is slanted at a specific angle to a scanning direction, and from embodiments in which a plurality of individual detectors are arranged along a circular line. Rather, the present invention is a specific combination of individual aspects of these two approaches.

In particular, the scanning apparatus is a laser scanner or a LIDAR (Light Detection and Ranging). The scanning apparatus can comprise a light transmitter that emits transmission light into the environment of the scanning apparatus, wherein the transmission light is reflected (e.g. remitted) by objects in the environment as reception light. The reception light can then be projected or imaged onto the detector arrangement by the optics described herein. The scanning apparatus is in particular configured to determine distance information on the objects in the environment from a time of flight of the transmission and/or reception light.

The detector arrays of the detector arrangement are preferably 1D arrays of detectors, in particular each (i.e. per array) on a single semiconductor substrate. The individual detectors are preferably designed in the form of non-resolved subarrays of CMOS sensors and/or of avalanche photodiodes.

Such designs can be packed particularly densely and thus provide a field of view with minimal distances between resolved regions. Non-resolved subarrays are understood as groups of detectors of a detector array that output a common detection signal. Specifically, each “detector” of a detector array can itself be a so-called “subarray” of individual sensors. As soon as at least one of these sensors senses a detection, the entire subarray emits a corresponding detection signal.

How many and/or which of the individual sensors have sensed the detection cannot necessarily be deduced from the output detection signal of the subarray.

The detector arrays of the detector arrangement preferably each comprise 16 to 128, for example 64, pixels or detectors, each in particular having a length of a few millimeters, in particular 1 mm to 20 mm. The outer diameter of the common circular ring preferably amounts to a few centimeters, in particular 1 cm to 5 cm.

The pixel number of the detector arrays corresponds to the number of resolved detectors of the detector array. In the above-described design with subarrays of CMOS sensors or avalanche photodiodes, the pixel number consequently corresponds to the number of subarrays of CMOS sensors or avalanche photodiodes and not to the product of the number of provided subarrays of CMOS sensors or avalanche photodiodes and to the number of individual CMOS sensors or avalanche photodiodes per subarray. Corresponding designs are particularly compact and still provide a high resolution.

A circuit board is preferably provided within the common circular ring of the detector arrays and comprises electronic components, in particular a control unit, an evaluation unit and/or a light source arrangement, that are different from the detector arrays described.

This enables a particularly compact overall design of the sensor unit with a sufficiently high resolution.

The detector arrays of the detector arrangement are preferably arranged on the common circular ring such that they span the entire outer diameter of the common circular ring in at least one transverse projection of said common circular ring.

In other words, the detector arrays are arranged such that they cover the entire width of the circular ring in the plane of the circular ring. This enables particularly compact overall designs of the detector arrangement and thus of the entire scanning apparatus.

The detector arrangement preferably comprises more than two detector arrays, in particular an even multiple of detector arrays, such as four, six or eight corresponding detector arrays, that are arranged on the common circular ring.

This enables the formation of a particularly narrow common circular ring and thus particularly compact overall designs. A further improved resolution can also be obtained via the plurality of detector arrays if the corresponding detector arrays are arranged transversely to a provided scanning direction at mutually oppositely disposed sections of the common circular ring with a suitable height offset. This height offset is in particular half the height of a detector or pixel transverse to the provided scanning direction. For example, two detector arrays arranged in parallel (in a plan view) can be arranged such that two detectors or pixels disposed orthogonally opposite one another with respect to the circular ring are displaced relative to one another by the size of half a detector or pixel.

The detector arrays of the detector arrangement are preferably arranged such that the width of the spanned common circular ring is less than or equal to one half, one third, one quarter and/or one fifth of half the inner diameter of the spanned circular ring. In addition or alternatively thereto, the detector arrays of the detector arrangement are preferably arranged such that the inner diameter of the spanned common circular ring is greater than half, two thirds and/or five sixths of the outer diameter of the spanned circular ring.

Corresponding designs allow a particularly compact design with a sufficiently high resolution.

The detector arrays of the detector arrangement are preferably arranged uniformly along at least one half of the periphery of the common circular ring, in particular along the entire periphery of the common circular ring.

This enables a maximum resolution with a minimal extent of the detector arrangement and thus of the scanning apparatus.

At least two detector arrays of the detector arrangement are preferably arranged disposed opposite one another relative to a radial axis of the common circular ring, but, viewed with respect to said radial axis, in particular at a height offset that is smaller than the effective pixel height transverse to this radial axis.

This enables a particularly high resolution with a certain redundancy for identifying and/or correcting individual pixel errors of the mutually oppositely disposed detector arrays. In this respect, the radial axis is preferably aligned in parallel with the provided scanning direction of the scanning apparatus.

The different detector arrays of the detector arrangement are preferably spanned over different sectors of the common circular ring. The different sectors spanned in this way preferably do not overlap or do not overlap significantly. The individual sectors preferably together define a closed circular ring.

A non-significant overlap is understood as an overlap smaller than or equal to the extent of a single pixel of the respective detector arrays. Such designs allow a particularly high resolution with a minimal spatial extent.

At least two of the detector arrays are preferably arranged at two different angles with respect to at least one radial axis of the common circular ring, wherein the two different angles in particular only differ from one another in their sign with respect to said radial axis.

The different orientation of the detector arrays enables the implementation of a particularly compact detector arrangement with a minimal width of the common circular ring. Allowing two corresponding angles to only differ from one another in their sign makes it possible, with a scanning direction along said radial axis, to ensure that both sensor arrays have the same resolution transverse to the scanning direction. This facilitates the combined evaluation of the detection signals of the respective detector arrays.

The scanning module preferably comprises at least one actuator for directly moving the detector arrays of the detector arrangement and/or an imaging unit, in particular having a rotating mirror or a facet mirror wheel, as well as at least one associated actuator in order to only move the field of view of the detector arrangement, in particular periodically and in particular substantially rotationally.

Such designs are to be formed as particularly compact and reliable.

The scanning apparatus preferably comprises a light source arrangement that is configured to illuminate the scanning zone of the scanning apparatus. The light source arrangement is preferably configured and/or equipped with an associated imaging unit such that said light source arrangement substantially only illuminates the field of view of the detector arrangement.

This enables a particularly efficient targeted illumination of the scanning zone or of the field of view of the detector arrangement. This in turn enables an improved resolution with sufficient eye safety by avoiding or at least reducing an unnecessary illumination of zones beyond the scanning zone of the scanning apparatus or even beyond the field of view of the detector arrangement.

The light source arrangement preferably comprises at least one light source that is arranged in accordance with at least one of the provided detector arrays and/or the common circular ring of the detector arrays of the detector arrangement.

For example, the scanning apparatus can comprise a light source that emits light in a circular ring that is concentric with the common circular ring of the detector arrays. The light source arrangement could, for example, also comprise a plurality of light source arrays, of which a respective at least one is at least aligned in parallel with at least one associated one of the provided detector arrays of the detector arrangement. Alternatively thereto, a light source arrangement is, for example, also possible that substantially illuminates the entire scanning zone or substantially only a zone that spans the field of view of the detector arrangement. A correspondingly focused illumination enables energy to be saved and makes it easier to ensure the compliance with eye safety requirements for the ultimately formed scanning apparatus by reducing the total illumination intensity provided.

The scanning apparatus preferably comprises at least one optics, in particular having at least one lens, alternatively in particular exactly one lens, and/or at least one parabolic mirror. At least one field diaphragm array is in particular positioned between the optics and the detector arrangement in the focal plane of the optics.

Corresponding optics enable a targeted guidance of outgoing and incoming light beams within the scanning apparatus and thus enable particularly compact and efficient overall designs for the scanning apparatus. If a light source arrangement is provided, common and/or separate optics can be provided for said light source arrangement and for the detector arrangement, depending on the spatial design. The provided optics preferably only sharply images on a circular ring. This sharply imaged circular ring preferably comprises or corresponds to the common circular ring of the detector arrays. The field diaphragm array preferably comprises a separate opening for each individual pixel or detector of the detector arrangement. Said openings are preferably each arranged exactly centrally above the associated pixel or detector. This enables a better subdivision of the field of view of the detector arrangement and a better separation of the respective input signals.

Due to an optics that only sharply images on a circular ring, the advantage of a simple and inexpensive optics results. The common circular ring preferably lies at least partly or completely within the sharply imaged circular ring so that a sharp imaging onto the detector arrays takes place. A blurred imaging or projection can take place within and outside the common circular ring.

The invention will be described purely by way of example with reference to the drawings in the following. There are shown:

FIG. 1 schematically, the design of an exemplary scanning apparatus within the meaning of the present invention;

FIG. 2 schematically, a frontal view of a first exemplary detector arrangement of a scanning apparatus according to the present invention; and

FIG. 3 schematically, a front view of a second exemplary detector arrangement of a scanning apparatus according to the present invention.

According to FIG. 1, an exemplary scanning apparatus 1 in accordance with the present invention comprises a detector arrangement 3 having a plurality of detectors 4 that are mounted on a common carrier plate 5. The detectors 4 are all oriented perpendicular to the carrier plate 5. The scanning apparatus 1 comprises a light transmitter (not shown) that transmits light into the environment of the scanning apparatus 1. The scanning apparatus 1 also comprises an optics 7 in the form of a simple convex lens. This optics 7 is connected upstream of the detectors 4 to deflect (received) light, which is emitted by an object 9, onto the individual detectors 4 in a specific manner. Light is hereby deflected from a specific region in front of the detector arrangement 1, its so-called field of view (FOV), onto the detectors 4.

In the present example, the scanning apparatus 1 further comprises a scanning module 11 having an actuator 13. The actuator 13 is coupled to the carrier plate 5 (and possibly to the optics 7) such that it can rotate the detector arrangement 3 with all its detectors 4 (and possibly the associated optics 7) about a fixed axis of rotation RA. From this, a circular scanning direction SR perpendicular to the image plane of FIG. 1 results for the scanning apparatus 1.

Alternatively thereto, a rotational scanning direction SR could, for example, also be obtained in that no movement of the detector arrangement 3 or of its detectors 4 takes place; rather, they are fixedly mounted and a rotatable imaging unit (not shown), in particular having a rotating mirror or a facet mirror wheel, is driven by the actuator 13.

It should be noted in this respect that the optics 7 can comprise other lenses and/or parabolic mirrors in addition to or as an alternative to the purely schematically shown lens. Forming suitable optics 7 and/or imaging units is within the capabilities of a skilled person. Consequently, this will not be looked at in further detail.

As can further be seen from FIG. 1, the scanning module 11 or the actuator 13 is connected at least at the output side to a further provided evaluation unit 15 of the scanning apparatus 1. The same applies to the detectors 4 that, for the sake of simplicity, is shown here via the connection of the carrier plate 5 with the evaluation unit 15. The evaluation unit 15 is configured to determine different information on objects 9 within the scanning zone of the scanning apparatus 1 from the combined signals of the individual detectors 4 and, in the present case, while considering a movement signal from the actuator 13. Corresponding evaluation methods are well known and will not be discussed further here.

At this point, it should also be noted that the evaluation unit 15 can also simultaneously function as a control unit for the actuator 13 and consequently does not have to be dependent on an output signal from the scanning unit 11. A skilled person will be able to think up a wide variety of causal relationships here. However, they are not of direct relevance to the present invention.

Even if a light source arrangement is not shown here for the sake of clarity, it is possible to supplement the basic design of FIG. 1 with a light source arrangement if required. A corresponding light source arrangement is in this respect coordinated with the specific design and mode of operation of the detector arrangement 3 and serves to illuminate at least the field of view of the detector arrangement 3, and possibly also the entire scanning zone of the scanning apparatus 1, as uniformly as possible. Possibilities for the specific implementation of a corresponding light source arrangement, possibly with corresponding optics, depend on the specific design and mode of operation of the remaining components of the scanning apparatus 1. However, the identification and implementation thereof falls under the capabilities of a skilled person and is therefore not dealt with further here.

Two exemplary designs for detector arrangements 3 for forming scanning apparatus 1 according to the invention will be described in the following with reference to FIGS. 2 and 3.

According to the first example of FIG. 2, a detector arrangement 3 in a scanning apparatus 1 according to the invention can comprise, for example, four different detector arrays 17 that are uniformly arranged on a common circular ring. In the present example, the provided detector arrays 17 are four identically designed 1D arrays of detectors 4. Each of the detectors 4 can be a subarray, for example of CMOS sensors or avalanche photodiodes.

A first detector array 17 is provided at the top left in the circular ring and is tilted at a first angle α₁ with respect to a horizontal radial axis (shown by a dashed line) of the circular ring. A second detector array 17 is provided at the bottom left in the circular ring and is tilted at a second angle α₂ with respect to the horizontal radial axis of the circular ring. A third detector array 17 is provided at the bottom right in the circular ring and is tilted at a third angle α₃ with respect to the horizontal radial axis of the circular ring. The fourth detector array 17 is provided at the top right in the circular ring and is tilted at a fourth angle α₄ with respect to the horizontal radial axis of the circular ring. The four tilt angles α₁ to α₄ are identical to one another in their magnitude. Furthermore, on closer inspection, it can be recognized (see in particular the dotted lines at the top and the bottom) that mutually oppositely disposed detector arrays 17 (here with respect to the vertical) are arranged with a height offset with respect to one another. In this respect, the height offset is preferably smaller than the effective pixel height (in relation to the height that in particular lies transversely to the scanning direction) of the provided detector arrays 17.

As is further shown in FIG. 2, the provided detector arrays 17 can span the entire circular ring and can to this end cover respective separate sectors of the circular ring that overlap insignificantly at most. The width B of the circular ring defined in this way is preferably less than or equal to a fraction of half the inner diameter Dᵢ (i.e. the inner radius) of the circular ring. Said inner diameter Dᵢ is preferably greater than half the outer diameter Dₐ of the circular ring. A circuit board having components (not shown) that are different from the detector arrays 17 can be provided in the interior of the circular ring.

The provided detector arrays 17 can be identical to one another or different from one another. They preferably each comprise a number of pixels or detectors 4 that are powers of two (such as 8, 16, 32, 64, etc.).

A second systematic example for a specification according to the invention of the detector arrangement 3 of a corresponding scanning apparatus 1 is shown in FIG. 3.

There, six mutually identical detector arrays 17 that each have eight pixels or detectors 4 arranged linearly in a row are arranged on a common circular ring. Four of the provided detector arrays 17 are arranged adjoining one another along the left half of the circular ring, while two further detector arrays 17 are arranged only in a central section of the right half of the circular ring. In this respect, a distance is formed between the two detector arrays 17 arranged at the right (see the dotted lines). This distance (or height offset) is smaller than the effective pixel height (i.e. the height of the pixels in their projection transverse to the scanning direction). Thus, the two right detector arrays 17 are arranged oppositely disposed with respect to their counterparts arranged at the left, but with a corresponding height offset.

In the example shown, a first angle α₁ of the uppermost detector array 17 relative to the horizontal radial axis of the detector arrangement 3 corresponds to a fourth angle α₄ of the lowermost detector array 17 relative to the horizontal radial axis of the detector arrangement 17. The further angles α₂, α₃, α₅ and α₆ of the remaining detector arrays relative to the horizontal radial axis of the detector arrangement (which simultaneously indicates the provided scanning direction) are identical in their magnitude to one another, but are different from the other two angles α₁ and α₄. This results not least from the specification hat the different detector arrays must be arranged on the common circular ring.

At this point, it should be noted that, according to the invention, it is not necessary for each of the provided detector arrays 17 to be fitted into the common circular ring such that their ends span the outer periphery of the common circular ring, while their central region tangentially contacts the inner periphery of the common circular ring. On the other hand, however, only those embodiments in which the different detector arrays 17 of the detector arrangement 3 actually span a circular ring, as shown by way of example in the two FIGS. 2 and 3, are to be regarded as being in accordance with the invention. Embodiments in which different detector arrays substantially span a rectangle or a flat circle (in the broadest sense, a circular ring with a negligibly small inner diameter) are expressly not to be regarded as being in accordance with the invention.

Furthermore, it is once again emphasized that the term detector array is understood as a combined component or module having a plurality of densely packed detectors and not merely as a loose collection of a plurality of individual detectors that are independent per se.

### REFERENCE NUMERAL LIST

1 scanning apparatus
3 detector arrangement
4 detector
5 carrier plate
7 optics/lens
9 object
11 scanning module
13 actuator
15 evaluation unit
17 detector array
B width of the circular ring
Dₐ inner diameter of the circular ring
Dᵢ outer diameter of the circular ring
RA axis of rotation
SR scanning direction

1. A scanning apparatus, the scanning apparatus comprising:
a detector arrangement having a plurality of optical detectors;
a scanning module that is configured to vary the position and/or the orientation of the field of view of the detector arrangement in order to define a corresponding scanning zone; and
an evaluation unit that is configured to obtain information on objects in the scanning zone of the scanning apparatus from the combined detection signals of the detectors of the detector arrangement,
wherein the optical detectors of the detector arrangement are designed in the form of at least two detector arrays that are oriented identically to one another and that each have at least three optical detectors arranged linearly in a row, and
said detector arrays are arranged on a common circular ring that extends perpendicular to the common orientation of said detector arrays.

2. The scanning apparatus according to claim 1, wherein the scanning apparatus is a laser scanner.

3. The scanning apparatus according to claim 1,
wherein the detector arrays of the detector arrangement are 1D arrays.

4. The scanning apparatus according to claim 3,
wherein the detector arrays of the detector arrangement are each on a single semiconductor substrate.

5. The scanning apparatus according to claim 3,
wherein the individual detectors are designed in the form of non-resolved subarrays of CMOS sensors and/or of avalanche photodiodes.

6. The scanning apparatus according to claim 1,
wherein the detector arrays of the detector arrangement each comprise 16 to 128 pixels or detectors.

7. The scanning apparatus according to claim 6,
wherein each pixel or detector has a length of a few millimeters.

8. The scanning apparatus according to claim,
wherein the outer diameter of the common circular ring amounts to a few centimeters.

9. The scanning apparatus according to claim 1,
wherein a circuit board is provided within the common circular ring of the detector arrays and comprises electronic components that are different from the detector arrays.

10. The scanning apparatus according to claim 1,
wherein the detector arrays of the detector arrangement are arranged on the common circular ring such that they span the entire outer diameter of the common circular ring in at least one transverse projection of said common circular ring.

11. The scanning apparatus according to claim 1,
wherein the detector arrangement comprises more than two detector arrays that are arranged on the common circular ring.

12. The scanning apparatus according to claim 11,
wherein the detector arrangement comprises an even multiple of detector arrays that are arranged on the common circular ring.

13. The scanning apparatus according to claim 1,
wherein the detector arrays of the detector arrangement are arranged such that
the width of the spanned common circular ring is less than or equal to one half, one third, one quarter and/or one fifth of half the inner diameter of the spanned circular ring; and/or
the inner diameter of the spanned common circular ring is greater than half, two thirds and/or five sixths of the outer diameter of the spanned circular ring.

14. The scanning apparatus according to claim 1,
wherein the detector arrays of the detector arrangement are arranged uniformly along at least one half of the periphery of the common circular ring.

15. The scanning apparatus according to claim 14,
wherein the detector arrays of the detector arrangement are arranged uniformly along the entire periphery of the common circular ring.

16. The scanning apparatus according to claim 1,
wherein at least two detector arrays of the detector arrangement are arranged disposed opposite one another relative to a radial axis of the common circular ring.

17. The scanning apparatus according to claim 16,
wherein at least two detector arrays of the detector arrangement are arranged disposed opposite one another relative to a radial axis of the common circular ring, but, viewed with respect to said radial axis, at a height offset that is smaller than the effective pixel height transverse to this radial axis.

18. The scanning apparatus according to claim 1,
wherein the different detector arrays of the detector arrangement are spanned over different sectors of the common circular ring.

19. The scanning apparatus according to claim 18,
wherein the different sectors spanned in this way do not overlap or do not overlap significantly and/or define a closed circular ring.

20. The scanning apparatus according to claim 1,
wherein at least two detector arrays are arranged at two different angles with respect to at least one radial axis of the common circular ring.

21. The scanning apparatus according to claim 20,
wherein the two different angles only differ from one another in their sign with respect to said radial axis.

22. The scanning apparatus according to claim 1,
wherein the scanning module comprises at least one actuator for directly moving the detector arrays of the detector arrangement and/or an imaging unit, as well as at least one associated actuator in order to only move the field of view of the detector arrangement.

23. The scanning apparatus according to claim 22,
wherein the at least one actuator has a rotating mirror or a facet mirror wheel.

24. The scanning apparatus according to claim 22,
wherein the at least one associated actuator only moves the field of view of the detector arrangement periodically.

25. The scanning apparatus according to claim 24,
wherein the at least one associated actuator only moves the field of view of the detector arrangement periodically and substantially rotationally.

26. The scanning apparatus according to claim 1,
wherein the scanning apparatus comprises a light source arrangement that is configured to illuminate the scanning zone of the scanning apparatus,
wherein the light source arrangement is configured and/or is equipped with an associated imaging unit such that said light source arrangement substantially only illuminates the field of view of the detector arrangement.

27. The scanning apparatus according to claim 26,
wherein the light source arrangement comprises at least one light source that is arranged in accordance with at least one of the provided detector arrays and/or the common circular ring of the detector arrays of the detector arrangement.

28. The scanning apparatus according to claim 1, comprising at least one optics and/or at least one parabolic mirror.

29. The scanning apparatus according to claim 28, further comprising at least one field diaphragm array that is positioned between the optics and the detector arrangement in the focal plane of the optics.
